(19) United States
(12) Patent Application Publication
(10) Pub. No.: US 2002/0040374 A1
(43) Pub. Date: Apr. 4, 2002

(54) Method for personalizing and customizing publications and customized publications produced thereby

(76) Inventor: Donald A. Kent, Carmel, IN (US)

Correspondence Address: E. Victor Indiano, Esq., Suite 850, One North Pennsylvania Street, Indianapolis, IN, 46204, US

(21) Appl. No.: 09/969,229

(22) Filed: Sep. 29, 2001

Related U.S. Application Data
(60) Provisional application No. 60/237,539, filed on Oct. 4, 2000.

(51) Int. Cl. G06F 17/00

(52) U.S. Cl. 707/516

(57) ABSTRACT

A method of producing a mass distributed publication through the creation of a plurality of subscriber specific versions, includes obtaining subscriber profile information relating to the nature of the subscriber's content preferences. A content database is provided that contains a plurality of content items. A computer is employed to select content items from the content databases, based upon the subscriber's content preferences. The selected items are forwarded to a high speed printer capable of printing at least one hundred pages per minute. The pages printed by the digital printer are then assembled into a unitary publication.

### TECHNICAL FIELD OF INVENTION

The present invention relates to printed publications and other printed materials, and more particularly to an improved method for customizing and personalizing content and/or making advertising individually relevant for printed publications.

### BACKGROUND OF THE INVENTION

Magazines, newspapers, and other printed publications for mass distribution are mass-produced for “the average target reader group” and usually contain both content and advertising. Traditionally, this content and advertising is focused to appeal to the average or typical target reader group of the particular publication. For example, Sail® magazine contains articles about and advertisements for sailboats, as that appeals to sailors and sailboat enthusiasts, who are the average target readers of the magazine. Although the contents of prior known publications are often targeted to a particular target group, it has heretofore not been possible to present specialized content and advertisements that have been customized and individualized to target the specific needs and interests of particular individuals.

Traditional printing technology requires massive printing runs of a single form of content and advertising in order to achieve a low-cost print price. With traditional printing technology, it is usually too expensive to provide any significant customization, personalization, or content/advertising variations. Additionally, a single repository or database of individual consumer preferences did not exist, that would permit individualized customization. Further, prior to the widespread use of the Internet, such a database would be difficult to acquire, as it would be too labor intensive to acquire and import into a printing systems.

The inability of traditional printing techniques to provide individualized content can negatively impact magazine sales, as magazine subscribers often cancel their subscriptions because the magazine does not contain enough relevant content to create a satisfactory price/value relationship for the consumer. Non-renewing subscribers often express this concept by giving reasons such as: (a) the publication costs too much for the amount of content that is relevant to me; (b) that its content doesn't meet her needs; and (c) that the customer does not have enough time to read it (the latter may be reflective that other forms of information or entertainment proved to be more efficient than the magazine), when asked why they did not renew their subscriptions. National surveys have indicated that the time spent reading magazines is decreasing, and that even serious magazine readers are reading fewer magazines. As further proof, the circulation of established magazines has been shown to have dropped by 11 million subscriptions during the 1990's.

Newspapers and other distributors of printed information have similar concerns and issues. Driving these concerns is the fact that while magazine and newspaper subscribers appreciate the offline flexibility and tangible nature of a magazine or newspaper, subscribers also want a product that contains articles and content of interest to them, and product advertising that is both useful to have and features services and products that are of interest to them.

Until the advent of digital printing, magazine and newspaper publishers could only offer publications on a non-customized, mass run, and “lowest common denominator” basis. Similar to broadcast television stations, magazine and newspaper publishers broadcast information and advertising in their publications in the hope that the magazine or newspaper contains some relevant content and advertising for most of their readers. Further, magazines and newspapers are a “brick and mortar” business and have not fully availed themselves of the interactive functionality that the Internet provides. Due to these reasons, advertisers make purchasing decisions with imperfect information and make advertisement placement decisions based upon estimates of what products the average reader may be interested in. From an advertiser's standpoint, the advertiser is usually required to publish his advertisement in a publication where only a fraction of the readers will be interested in the advertizer's product. As a result, the advertiser is unable to focus his advertisement as sharply as she would like. As a corollary, since the cost of an advertisement is usually directly related to the number of circulated copies of the publication, some smaller or regional advertisers are unable to afford to advertize their products in certain widely-circulated or nationally-circulated publications.

It is therefore one object of the present invention to provide a method for producing a publication that better facilitates the customization of the particular publication to the desires of an individual, or a small group of subscribers, and/or advertisers.

### SUMMARY OF THE INVENTION

In accordance with the present invention, a method of producing a mass distributed publication through the creation of a plurality of subscriber specific versions, comprises: obtaining subscriber profile information relating to the nature of the subscriber's content preferences. A content database is provided that contains a plurality of content items. A computer is employed to select content items from the content databases, based upon the subscriber's content preferences. The selected items are forwarded to a high speed digital color or black and white printer capable of printing at least one hundred pages per minute. The pages printed by the digital printer are then assembled into a unitary publication.

The method of the present invention comprises a new publication process that employs the efficiency of the Internet and digital printing to create significant efficiencies for magazines, newspapers, other mass publications, and customized printed products while better serving the individualized needs of consumers and advertisers. The Internet allows users to interactively customize and personalize printed material with their personal content and advertising preferences. Digital printing allows publishers to economically print a customized publication for a specific customer. The efficiency of digital printing combined with the flexibility of the Internet allows users to customize and personalize preferences and permits advertisers to effectively target consumers on a relevant and one-to-one basis.

With the process of the present invention, consumers can customize and personalize magazines, newspapers, and other printed products they receive or order to incorporate the layout (e.g., size of print) type of content, genres of information, and the category and types of advertising that match their needs and requirements via a wizard or interactive set of questions on the publisher's website. The information received from consumers about their preferences is distributed to publishers with digital printers (or to third-party print houses) that format and personalize magazines, newspapers, and other publications to meet the needs of their subscribers, thereby resulting in increased circulation and reduced loss of subscribers. Additionally, advertisers can more effectively target potential users of their products on an opt-in basis via subscriber response on the website and via predictive software based upon online and offline consumer databases.

Accordingly, several advantages of the present invention exist over the prior art. One advantage is that the publisher's costs of producing the publication may be reduced. Since the publication will contain only that content (and advertising) that is useful and relevant (either by request or with predictive software) to the consumer, the publisher will require less ink and less paper to print the relevant or useful information. As the publication will meet the individual needs and requirements of each consumer, customer churn (turnover) is reduced, thereby reducing the publisher's expenditure of marketing and sales dollars (including discounted “new subscriber” subscriptions) to replace the customers who cancel their subscription with new subscribers.

A second advantage is that advertisers are able to spend their advertising dollars more cost-effectively. Because this invention targets each consumer through advertising that is opt-in, predictive, or based upon a database of the consumers' experience or individual demographics, the advertising is more relevant and useful to the consumer. Consequently, consumers will find the advertising in the publication to be more helpful and will be more likely to act upon the suggestions of the advertising that has been customized for him/her, when compared to advertising that is more generalized to reach a less targeted audience. The advertisers' costs (CPMs) will be reduced because of the substantial increase in the efficiency of the customized advertising. In some cases, the consumer will provide the publisher with a physical address for the physical distribution of the publication and an email address when accessing their profile on the Internet. This allows the publisher or some third party to provide a targeted and coordinated form of physical and electronic communication, content and/or advertising to the consumer from one database with a consumer's profile, which may be most appreciated if the consumer opts in for this type of targeted and coordinated information.

A third advantage is that the consumer will receive greater value. Because the advertising is significantly more effective, the savings realized by advertisers may be shared with the publishers and passed along to the consumer as an inducement to share his/her advertising preferences. Additionally, as the advertisements and content of the publication will be customized for the individual consumer, the consumer will find the publication to be more relevant to his needs, and contain fewer materials within the publication that are of no interest to him or her.

A further advantage of the present invention is that it may help to reduce the publisher's distribution and postage costs. The increase in efficiency achieved by reducing irrelevant content and advertising reduces the number of pages required to maintain a constant price/value ratio for the consumer. This reduction in weight can reduce postage and distribution costs.

An additional advantage of the present invention is that it provides a novel reading experience for the consumer. In a world where time is precious, the customized and personalized nature of this invention saves reading time, makes readers more efficient, and creates a more pleasurable customer experience. Furthermore, this invention marries the interactive and customizing functionality of the digital world with brick and mortar publishing companies.

It is also a feature of the present invention that it provides increased convenience for the subscriber. Subscribers read content and advertising that is relevant and useful to them based upon the parameters that they have established. This way, consumers can ensure that the publications they receive are valuable and have useful content, without requiring the customer to flip through pages of content that are not relevant or useful. Consumers may be able to reduce the sources of information that they employ to gather information and be able to allow published materials to meet a greater percentage of their education, information, and entertainment needs. All of this will result in time savings to the customer.

Another feature of the present invention is that it will be more environmentally friendly than prior art publications. Since less materials (primarily paper and ink) will be required to maintain a consistent price/value relationship for the consumer, fewer trees will need to be harvested for paper production, less polluting paper manufacturing will be required, and less waste material will need to be transported to landfills and disposed.

A further feature of the present invention is that its ability to produce individually customized, and small group customized publications will aid in the ability of the publication to serve as an educational tool. For example, a “Current Events” teacher can order a customized “small group election” of a publication for her class to cover those topics that the teacher believes relevant to her intended curriculum (e.g. politics, technology, world events), while eliminating those topics (e.g. celebrities, religion, sports) that she deems either not relevant to her curriculum, or else inappropriate for a school setting. Similarly, through the present invention, a teacher has the ability to order a textbook that is customized to emphasize those topics she believes important, while minimizing or eliminating those topics she believes less relevant.

For advertisers, one feature of the present invention is that it can increase the salability of their products. Publications that are customized and personalized more efficiently meet the requirements of individual consumers and are an increasingly important driver of sales of products advertised therein. The present invention helps to ensure that publishers can meet readers' individual needs, by marrying the one-to-one and interactive power of the web with the customer attraction powers of a traditional brick and mortar business.

The present invention also permits the publisher to choose the amount to which he or she will permit subscribers to customize the publication. For example, publishers can decide to allow consumers to fully customize or personalize a publication. Alternately, the publisher can decide to retain a portion of the publication as a core product and limit consumers to being able to personalize or customize only specific sections within the publication. This could increase the speed of printing jobs, reduce costs, or ensure the publication maintained a consistent brand image. The present invention will help publishers of magazines, newspapers, and other printed materials to more effectively compete with e-zines and online competitors. New markets will be created, such as a greater array of foreign language versions of publications, and versions with larger type sizes for sight-impaired readers.

The present invention also contains the potential to provide more viewable publications. Since the present invention allows readers to customize and personalize their publication, sight-impaired readers may be able to choose large type, and color blind (or partially color blind) readers may choose a print color that is readable to them. Consumers desiring a higher picture-to-print ratio can customize their experience to provide for a publication having a greater picture content.

One feature of the present invention is that language translation software can be employed to translate the publication into a variety of languages. This feature has the advantage of increasing the potential market size of the publication. With language translation software, readers are able to order magazines in foreign languages (or one magazine in two languages), thus increasing the demand for publications using this invention. The publisher is also able to increase the market size of the publication by increasing the degree of market penetration of the publication.

The present invention can increase magazine and newspaper penetration to readers that have terminated their subscriptions because the product did not provide a satisfactory price/value relationship, did not contain sufficient relevant or useful content, or from consumers who use other sources for information and entertainment. Further, it may encourage those occasional readers of a publication (i.e. those who purchase the publication on a per copy basis at newsstands or grocery stores) to purchase a subscription to enable them to take advantage of the personalized features of the publication. Finally, readers that have not subscribed may be induced to subscribe.

A further advantage of the present invention is that it enables the publisher to produce a higher quality, more exciting publication. The present invention creates a higher quality product because it is better targeted to the end user. A publisher can significantly expand the content available to be personalized in a publication by contracting or purchasing content from other content sources. As an example, a customized local newspaper could include the New York Time's famous crossword puzzles. Additionally, the marriage of the Internet and customer preference to create an enhanced product will create consumer excitement from the shear newness of the product. Further, the customized nature of the magazine has the potential to make the publication more profitable.

If publishers use the customization and personalization to improve the price/value ratio of their product, then publishers should be able to charge a higher price to consumers commensurate with the increased value of the service.

It is also an advantage of the present invention that it satisfies an existing need. The interactive and customizable nature of the Internet is driving users to access and utilize the Internet. The present invention allows users to bring the power of the Internet to a tangible product that they have enjoyed for years.

Further objects and advantages of my invention will become apparent from a consideration of the drawings and ensuing descriptions.

### BRIEF DESCRIPTION OF THE DRAWINGS

FIG. 1 is a flow chart that schematically illustrates the primary components involved in the method and device of the present invention.

FIG. 2 is a schematic representation of the primary input screens of the present invention.

FIG. 3 is a schematic representation of the secondary, personal information input screens of the present invention.

FIG. 4 is a schematic representation of an exemplary secondary content input screen of the present invention;

FIG. 5 is a schematic representation illustrating the various relationships among the components of the present invention; and

FIG. 6 is a flow chart illustrating a method for producing the editorial and advertising content of the publication of the present invention.

### DETAILED DESCRIPTION OF PREFERRED EMBODIMENTS

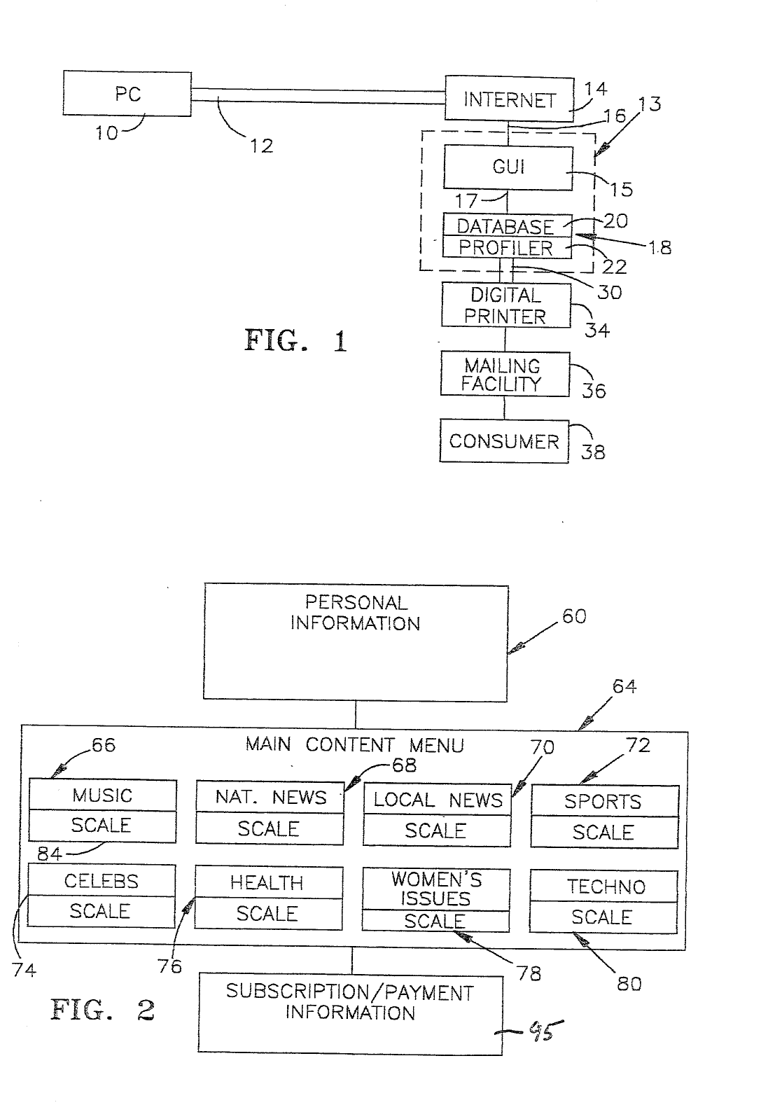

Turning now to FIG. 1, a schematic view showing the relationship between the major components of the present invention is depicted.

An Internet accessible device, such as a personal computer 10 is connected via a communication device, such as a telephone line 12, to the Internet 14. The Internet 14 is connected to the publisher's facility (or, alternately, a third party facility providing this service for a publisher) 13 by a communications device 16, such as a telephone line, cable connection, wireless connection, etc. The publisher's facility includes a server 13 or main frame housing a graphical user interface, GUI 15 that is coupled by a communication means 17, or as part of a server containing a database/profiler component 18.

The above components permit the user's PC 10 to interact with the publisher's server 13 to create the customized magazine of the present invention. Once the user has interacted with the server 13 at the publisher's site to create her own customized publication, the publisher's server 13 can assemble necessary content and advertising to create the custom-content publication of the present invention. This custom content is then output through a communication means 13 to a digital printer 34, that may be at the publisher's location, subscriber's location, or at a distant printing facility. A digital printer 34 prints the customized magazine. Once printed, the customized magazine is shipped by a mailing facility 36 such as the U.S. Postal Service, to the consumer 38 who receives it at her home.

One example of a selection process by which the user can select information and content for a hypothetical magazine will now be described in connection with FIGS. 2-4.

As shown in FIG. 2, the first step that a new consumer must usually take after establishing communication with the publisher's server 13, is to provide information about herself that the publisher can use to produce the magazine. The first major set of information that the user will tender is personal information, as represented by personal information screen 60. Once the user has entered appropriate information, he will then view the next in a series of screens that comprise the personal information menu. Although it may be possible to place the entire personal information menu on a single screen, it is envisioned that the amount and variety of personal information will dictate that the user review a series of screens in order to fully input all of the personal information necessary. After all of the necessary personal information is input, the user needs to go through a series of content-related menu pages (screens) to select appropriate content for the magazine.

In FIG. 2, the main content menu 64 is shown as a menu that contains a variety of categories from which the user can select. In the hypothetical example that will follow in this description, the magazine that is being constructed is a general interest-type magazine such as Time or Newsweek. Main content menu 64 contains a variety (here shown as 8) of large or primary categories from which the user can develop content.

These categories shown in the main content menu include a music section select 66, a national news section select 68, a local news section select 70, a sports section select 72, 20 a celebrity and personality section select 74, a health issue section select 76, a women's issues section select 78, and a technology section select 80.

Turning now to the music section select 66, you will notice that it includes a “scale” portion 84. Similarly, all of the various section selects 68-80 also include scale portions. The scale portion 84 is employed by the subscriber to attach semi-quantitabive priority weights to the particular sections. Although the particular type of scale used (e.g. one to ten scale, percentage scale, 1-5 stars scale, etc.) is largely arbitrary, the information that can be gleaned by the publisher from the scale is the relative weighting of the importance of the subject matter to the user. For example, a subscriber who is very interested in music, but unconcerned about technology issues, would give a high priority (e.g. 9 on a 1 to 10 scale, or 4 stars on a 1 to 5 star scale) to the music section 66 and a low rating to the technology section on the technology scale 80 (e.g. 2 on a 1 to 10 scale, or 1 star on a 1 to 5 star scale). Additionally, should the user desire, she could seek to set a “0” value on the scale, suggesting that she wanted to receive no information about that particular issue.

Once the user has made her content selection, the final step in the process is for the publisher to elicit subscription and payment information from the user, depicted by screen 95 of FIG. 2. The information contained on this section includes things such as the length of the subscription desired by the user, and a charge card account number, such as a VISA® card account number, or a Mastercard® account number or a bank debit card account number from which the publisher can draw payment from the user.

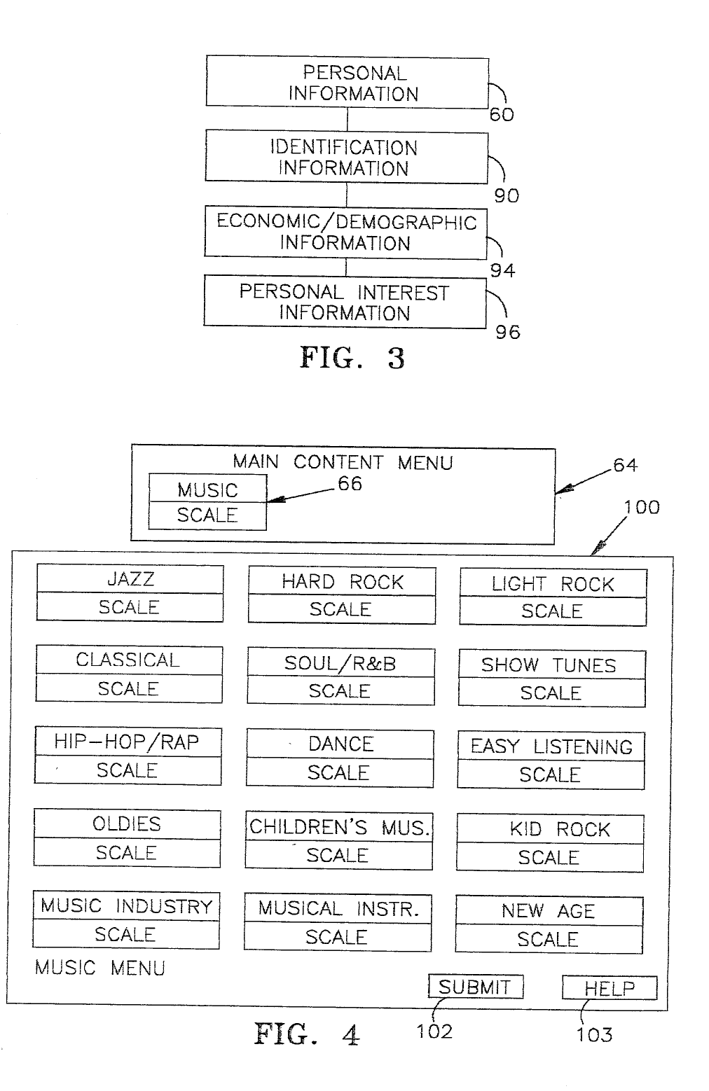

Turning now to FIG. 3, the personal information 60 category is expanded to illustrate the various types of personal information that the publisher may wish to acquire from the subscriber. The first type of information is identification information about the subscriber, such as name, address, e-mail address, phone number, etc. The second block 90 contains identification information. The third block 94 of information comprises economic and demographic information 94. This information is useful to the publisher both to help the publisher better understand the demographic cross section of her readers, and thus better help attract advertisers; and also better enable the publisher to select appropriate advertisements and content to integrate into the content of the publication. For example, the publisher may not wish to include advertisements for expensive luxury cars to subscribers with poverty line income levels.

The fourth block of information 96 comprises personal interest information. Obtaining personal interest information from subscribers also better helps the publisher to select advertising and content that is better to the interest of the subscribers. Additionally, having this information makes the subscriber list that the publisher accumulates from all of the various subscribers more attractive to direct mail houses, charities, and other organizations that engage in target marketing. For example, if a substantial number of the subscribers indicated on the personal information block 96 that they enjoyed photography, the publisher may be able to mine this information from his subscriber database, to prepare a mailing list that would be valuable to camera and film companies, as the persons on the list would already have expressed a desire to engage in photographic pursuits.

Turning now to FIG. 4, one exemplary selection process will be described in more detail. As discussed above, a main content menu 64 can exist where some or all of the major content categories are listed such as content categories 66-80. Assuming that the subscriber chose to include music content 66 within his publication (regardless of the scale reading), a secondary content screen, such as content screen 100 would then appear. In the secondary content screen 100, the primary category (music 66) is subdivided into a plurality of subcategories such as jazz, hard rock, show tunes, kid rock, and new age, music industry news, and musical instruments information. From this secondary contact (sub-category) screen 100, the user can then pick the types of musical information about which she is most interested. This selection can be made both by choosing to include only certain categories in which there is interest, or by using the scale setting to reflect the subscriber's relative interest in the various subcategories shown on the screen.

One difficulty that may arise with a subcategory screen 100 having a plurality of sections is that the infinite variety that it provides the user may result in requiring the user to spend more time creating the selection scale than the user would otherwise desire. To overcome this problem, the secondary screen 100 (and, for that matter, the primary category screens 66-80) can be created to have a default scale for each of the various subcategories, that the user could accept in toto, or which the user would be able to vary on a setting by setting basis. In setting the default scale, the publisher can either choose to make all of the categories equal (e.g. 5 on a 1-10 scale) or could vary the categories based on market or content input. For example, if the publisher's market research indicated that the magazine's readers tended to be older empty-nesters, the publisher may, based on that information, set a relatively higher default scale for jazz, classical music, show tunes, and easy-listening music, and a relatively lower default scale for hip-hop/rap, dance, kid rock and children's music.

In any event, when presented with a secondary music menu 100, the user will 20 make her selections. The user then clicks on the submit button 102, when she has finalized her selections on the music secondary menu 100, or clicks on the “help” button 103 if on-line help is desired. The help screen can be designed to permit communication with a human at the publisher's help desk, or could merely provide examples of the content of each subcategory (e.g. Bach, Beethoven, the New York Philharmonic Orchestra in the Classical Music sub-category). After completing the secondary music menu 100, the program returns the user back to either the main content menu, or a secondary menu of another main content category selected by the user.

One feature that is achievable with the method of the present invention is that it enables the user to reduce the number of magazines that he purchases, by combining the desired features from several different magazines into one publication. For example, a hypothetical reader may especially enjoy the national and international news features of a magazine such as Time or Newsweek, the celebrity interest features of a magazine such as People or Us, the sail racing features of a magazine such as Sailing and the hockey stories of Sports Illustrated; but not enjoy other features contained in the magazines, such as the medicine and law news sections in Time or Newsweek; or the music and video sections in People or Us. Rather than order all four magazines, the subscriber can select content from all four magazines to produce a single magazine that provides him with those portions of each of the magazines that he enjoys most, without being forced to buy the sections of the magazines for which he cares little.

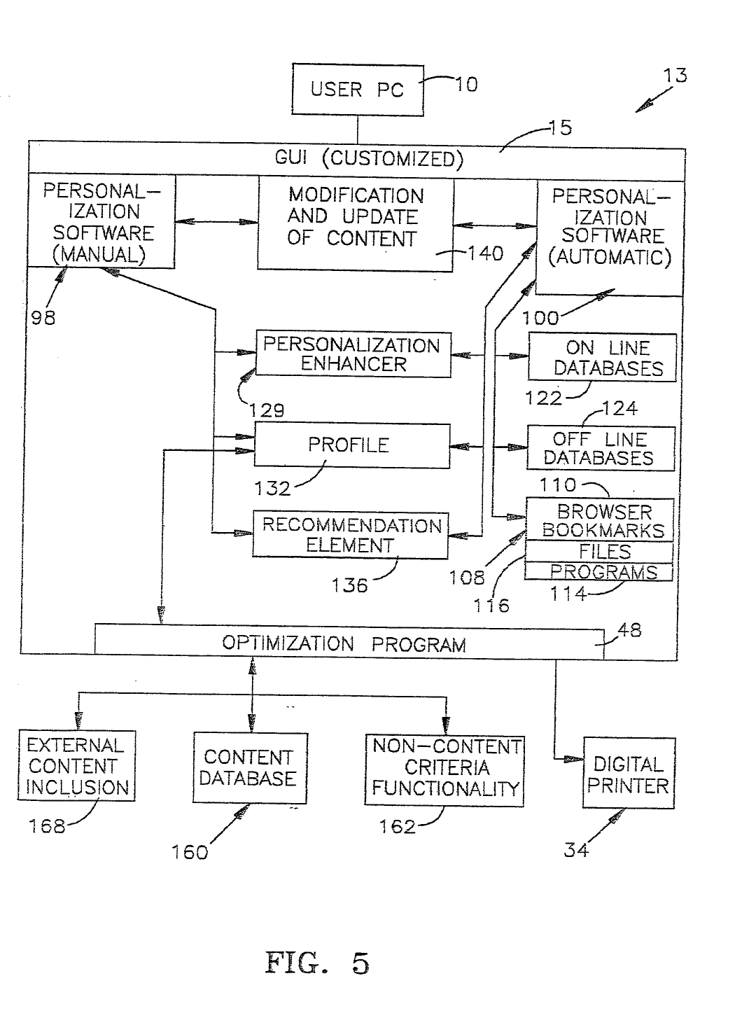

In FIG. 5, the web accessing electronic device (here, PC 10) may include a processor and may be tested for conformance with industry and/or regulatory standards. The device 10 may, for example, be a computer such as a desktop or laptop, a PC, or a personal data assistant (PDA), a cellular telephone, personal communications device, a television set top converter, or a household appliance. The exemplary embodiment described below is described in conjunction with a personal computer 10. Suitable electronic components and circuits for carrying out the operations of the various functions are known to those skilled in the art.

The PC device 10 is connected to the publisher's server 13 either directly, or preferably through the Internet 14 via an electronic connection. Such a connection can, take the form of a modem, local area network (LAN), wide area network (WAN), or of a physically cabled or wireless Internet connection. The physical connectivity could use various type of “cabling,” including but not limited to coaxial cable or twisted pair cabling. A wireless connection can use various frequencies, including for example, multiple multipoint distribution system (MMDS), local multipoint distribution system (LMDS), or direct broadcast system (DBS) frequencies.

If the database server 13 is accessed via the Internet 14, the physical or wireless connection may use a modem (not shown) to connect to the Internet through various forms of technology. These technology forms include such things as dial ups through twisted pair telephone lines and the telephone infrastructure, digital subscriber lines (DSL) through telephone lines and the telephone infrastructure, or cable modem technology through coaxial cable and a community antenna television system (CATV) and a wireless connection via a DBS satellite. If the database server 13 is offline or not accessed via an Internet connection, it may use other ISDN or a T-1 connection via twisted pair or coaxial cable to connect to the aforementioned connections for connecting the PC 10 to the publisher's database sever 13.

The database/profiler 18 may be online via the Internet 14 or offline and stored in an electronic device that contains either memory or storage and a processor, such as the publisher's server 13. The database includes a front end or a graphical user interface (GUI) 15 that allows users accessing the database 18 to do so in an efficient and functional manner. The database 15 can use commercially available software such as Microsoft Sequel (MSSQL), Microsoft Excel or Microsoft Access. Alternately, the database 18 can comprise a customized and proprietary database. The architecture of the database can be created in a manner so that it permits a dynamic restructuring of information so that users would realize maximum flexibility when personalizing their printed materials.

One feature of the GUI 15 is to provide various customizable and non-customizable functions and depictions. An example of a customizable function is the name and/or logo or other identifying mark of a product or a company. Also, the GUI 15 can have different skins that are selectable by the user and/or publisher to provide a customizable look and feel, or allow for the importation of customized skins that adhere to pre-established parameters. Individual users may personalize some of the customized features whereas other elements may be fixed and not subject to personalization by an individual user.

The exemplary embodiment described below is a user personalizing and ordering a magazine. However, this invention is designed to provide efficiency on all printed materials and another example of an application could be a newspaper, a business newsletter, a book of blank checks customized with a picture of a parent's children, or a literature anthology.

The personalization functions of the present invention can be designed to enable the user to perform the publication personalization either: (1) manually; (2) in an automated manner via profiling; or (3) via a combination thereof. Typical content for this invention when used in connection with a magazine includes, but is not limited to, editorial information, advertising information and genres of categories of different subject matters of information. These categories are limited only by the imagination of man, and the interest of the magazine's readers. Among the topics that might be found in a general interest magazine include are editorial information, and genres of categories such as national news, regional news, local news, biographies, opinions, beauty, fashion, fitness, heath, diet, recipes, parent's guidance, profiles, letters to the editor, buyer's guides, money, finance, psychology, etiquette, technology, science, people, style, beauty, relationships, well-being, travel, features, games, celebrities, and others depending upon the type focus, and available content of the magazine.

A user is able to manually enter information into a predefined or free form format to personalize the writings and illustrations in a magazine through the use of a manual personalization software program 98 (FIG. 5). The format can include such things as a template that allows users to either select, deselect, or use a combination of selecting and deselecting to choose content. For example, a magazine's detailed table of content or its index can be displayed, and the user can use this table of contents as a benchmark or check list for personalizing the editorial content that they wish to include in their customized publication. As another example, all of the content can be exhibited in a set-subset representation. As a further example, the primary categories (e.g. news) can be specified and the users can double click on content (which would then reveal more detailed subcategories such as local news, political news, etc.) to drill down and either select or deselect particular content items that she either desires to include or exclude from her publication. Alternatively, major catagories of content can be depicted in the “trunk” of a tree and branch design, with sub-catagories of the major catagory being displayed in the branch portion of the tree.

As another alternative, the user can enter key words or phrases of content that are to be included or excluded. A summary of the content that is to be included (or excluded) would then be visually depicted in the form of a list shown on the screen of the device 10.

Alternatively, the user can enter a key word or phrase that dynamically searches a database for relevant articles to populate the magazine. In this example, the program links related forms of information (i.e., “French”+“1930s”+“aircraft”) into a category of 1930s era French owned or operated aircraft and draws from a database that contains content for the magazine that is related to this subject area. As another example, the list can be in the form of a tree and branch with colors used to differentiate whether the content is to be included or excluded.

Another way to personalize content is to use the table of contents as a benchmark and have the user double click on the content to reveal subcategories of more detailed content. Another form of manual profiling personalization is to exhibit a copy of a magazine, and allow the user to drag and toss selections via a mouse or keyboard.

In addition to the content of the publication being variable and customizable, the pricing to the subscriber can also be variable and customizable by setting “per item” prices for the content selected by the users. Product pricing screens can be established so that adding or decreasing content affects the cost of the printed matter to the user.

As another example and in the case of a magazine, the subscription fee (and/or the change of a fee, an existing fee or price structure) is depicted so that the user can immediately determine the effect of adding or deleting categories of content, including sections from more than one magazine (e.g. combining Time® magazine with Sports Illustrated® magazine). Based upon the user's profile, advertising is dynamically created via a database that links predicted content together. An optimizing program 48 (see FIG. 5) matches the profiles and ensures that the database of content is efficiently correlated to match the user's requests and/or interests.

In addition to magazine articles and editorials, another form of content is advertising, which includes but is not limited to narrative, illustrations (drawings and pictures), samples of products, and etc. The advertising generated for a particular user can be based upon a manual profiling. The user profile is created by obtaining information about the user, such as demographic data, psychographic data, planned purchase decisions, past purchasing decisions, and/or lifestyle questions). By gathering this information, the present invention can provide a user with advertising that is interesting and useful to him/her.

Additionally, by using the manual functionality described above, the user can employ one of a series of formats to select, deselect, include, or exclude specific products or product categories. Adding or decreasing content could affect or modify the cost of the printed matter to the user. In the case of a magazine, the subscription fee (and/or the change of an existing price structure for users with a current subscription) can be displayed so that the user can immediately determine and see the effect of adding or deleting categories of advertising content.

Based upon the user's profile, an advertising content package is dynamically created via a database that links predicted content together. As an example, a program can be used to query the user's profile information to determine that the user had children, access the user's home page to retrieve screen shots of his/her children, and dynamically modify an advertisement so that the advertisement includes a picture of the children superimposed (or incorporated) in the advertisement. Alternatively, the inference could be substantially subtler, by including an advertisement with children aged 5-8 when a search of the user's profile identifies that he/she has children that are aged 5-8. An optimizing program 48 matches the profile and ensures that the database of content is efficiency correlated to match the user's requests and/or interests.

The subscriber can also (or in place thereof) activate an automatic personalization software program 100 that searches, identifies for relevance, and places in priority certain information that provides data for the automatic profiling function of the present invention. When activated, the automatic personalization program 100 conducts a search for data that is capable of providing information about the user. For example, the program can search the files, records, or programs (schematically represented as box 108 of FIG. 4) within the user's device (e.g. PC 10). These files records and programs include such things as browser bookmarks 110, downloaded files, type of programs 114 on the computer 10, and files 116 in the document and briefcase folders).

In addition to mining data from the user's PC 10, the personalization program can mine data from an online database via an electronic connection. Mineable information in such an online program can include, for example, the user's previously established profile in another database, data in an offline database 124 via an electronic connection, or a combination of the above-mentioned searches. Examples of data in online databases include credit card purchase databases, credit check databases, and other databases that contain public and lawfilly obtainable private information. This retrieved information is reviewed for relevance by criteria previously established within the program, or interactively established by the program. The automated personalization program 100 can have an artificial intelligence engine and/or predictive software that establishes priorities based upon criteria that can include for example, some or all of the following:

(1) the types of data identified (i.e., files, programs, or records); (2) key words found within the data; (3) the date that the data was created or updated to optimize, through the optimization program 48, and/or the relevance of content to the user's profile: and (4) other priorities.

In addition to the use of the automated personalization program 100 to help select relevant magazine articles, the software 100 can also be used to select advertising content. Based upon the search conducted by the automatic personalization software 100, the data would be ranked for relevance by criteria established within or by the program 100. The automated profiling program 100 can have an artificial intelligence engine and/or predictive software that establishes priorities based upon criteria that may include, inter alia, some or all of the following: (1) the types of data identified (i.e., files, programs, or records); (2) key words found within the data; (3) the date that the data was created or updated; and (4) other priorities. As described above in connection with the automatic personalization software 100, the search could include searches for the files 116, data e.g. 110 and programs 114 and records in the user's device 10, from online databases 122, and from offline databases 124.

The manual operation of the manual personalization software 98 can be enhanced with automated functionality that makes suggestions based upon the users inclusions or exclusions of content, thus guiding and making more efficient the manually established criteria. This function is accomplished with the personalization enhancer element 129 of the system. For example, a user that employed the keyword functionality for including or adding a catagory (e.g. music), could be offered related topics (e.g. new CD releases) or individuals (e.g. Billy Joel, REM, Backstreet Boys) relevant to that category.

Alternately, automated profiling program 100 can be used to establish a base of preferences for the user, after which the user can fine-tune the selections manually through the use of the manual personalization software 98. Alternatively, a wizard can help a user step through a selection of choices and alternatives to facilitate the user's selection or de-selection process. The process is discussed above, in connection with the content choice process described in connection with FIGS. 2 and 4. An optimization program 48 matches the content with the profile 132 and ensures that the database of content was efficiency correlated to match the user's requests and/or interests.

A recommendation element 136 of the system can be employed to recommend additional magazines, services, or products based upon the personalization or profiling established by the user. As an example, software could anonymously identify profiles of other subscribers with similar likes and dislikes and make suggestions on the basis of what other individuals with similar likes and dislikes have requested. Users could be enticed to purchase these additional suggested magazines or products by offering incentives for the purchase, such as packaging price discounts or through the use of premiums.

Additionally, the user's profile 132 could be used to provide the user with other forms of advertising and promotions, such as coupons and/or samples that can be included in the magazine if it is mailed or physically distributed by a third party to the subscriber. Adding or decreasing content, or agreeing to subscribe to the magazine, and purchase, sample, or receive additional information about products or services could affect the cost of the printed matter to the user.

Modification and update of content element 140 exists for advertising, editorial content, and/or other printed matters. The printed material can be modified and/or updated by the user and/or modified and/or updated automatically. Using a magazine as an illustration, the user can review his/her profile and make changes in a manner similar to the manner that the content parameters were originally created (or by using a variation thereof). Consequently, a user can retrieve the profile she created for a specific magazine, which, for purposes of illustration, may be in the form of tree and branch architecture. The user then undertakes a process similar to the initial decision process to modify content, such as selecting and/or deselecting content. An updated profile is created and saved.

Alternately, a screen shot of the most recent publication is retrieved (or created) and the user highlights content that is to be modified or deleted. Another example is that some of the content (such as all or some of the advertising) can be eliminated by the user. As discussed above, the pricing of the product may be variable, so that adding or decreasing content will impact the cost of the end product publication to the user. For example, the elimination of some or all of the magazine's advertising, could cause the price to increase to compensate the publisher for the attendant reduction in revenue.

The content of the magazine, including its advertising, editorial, and of content can also be modified or updated automatically. A search (as described in connection with the automatic personalization software 100) can be periodically conducted to update the users profile. Alternately, the addition of a number or type of files, programs, or folders can trigger an automated update. Finally, the software of the present invention can be designed so that modifications to an online or offline database (e.g. additions or deletions to the user's Internet browser's “favorites” database can preferably trigger an automatic update to the user's profile 132.

These proposed automated changes can be communicated to the subscriber via email, on the GUI 15, or in some other manner (e.g. telephone). The subscriber can review the changes and choose to accept them, decline them, or modify them. The modification can be done with a program or a file embedded within the e-mail, after which the user would e-mail the modifications back to his profile 132, which would be updated automatically. Alternatively, the e-mail can contain a link or some other mechanism to allow the user to make the modifications directly on the GUI 15.

The optimization program 48 is designed to optimize the various parameters established in the profile 132 and correlate it to the database content 160 (FIG. 5) when it is time to print the publication. The formation and solution of an optimization problem involves the establishment of evaluation criteria based upon the objectives of the optimization problem, followed by a determination of the optimum values of the controllable or independent parameters that will best satisfy the evaluation criteria. The optimum values are determined by the analytical manipulation of the criterion functions, which relates the effects of the independent parameters on the dependent evaluation criterion parameters. In most optimization programs, there are a number of conflict evaluation criteria and a compromise must be reached through a trade-off process in which relative value judgments are made among the conflict criteria. The main task of the optimization program 48 is to maximize the subscriber's satisfaction by choosing content that best correlates to the user profile 132. Therefore, there are multiple dependent evaluation criterion parameters, including but not limited to the prioritized list of content that is desired versus the available content in the content database 160.

These criteria will depend upon a set of independent parameters. In the case of the subscriber's profile's priorities, the important independent parameters are the user's preferences and the available content. As will be recognized, these important parameters are the ones that can be controlled by the user or the content provider. The values of the independent parameters determine the resulting prioritization of the content. In those cases where the user specifies insufficient content, predictive software will estimate the user's interests based upon other information in the profile such as demographic information or psychographic information about the user. Conflicting criteria will be prioritized by a program that ranks and predicts the user's values based upon the information in his/her profile.

A database of content 160, that contains editorial content and advertising is created and is accessed by the optimization program 48. Each item of content contains a corresponding code that permits the profiling program 132 that has been optimized via the optimization program 48 to select the most relevant content in the content database 160 for the particular subscriber, based on the “profile” of the subscriber created by the profiling program 132. The content of database 160 may be generated from external, online databases 122, an internal database, such as offline database 124, or from the user's own PC 108. With respect to an online database 122, the database 122 can use commercially available software such as Microsoft Sequel (MSSQL), Microsoft Excel or Microsoft Access, or can be a customized and proprietary database. Preferably, the database 122 is constructed in such a manner so as to permit a dynamic restructuring of information so that users realize maximum flexibility when creating their personalized publication.

Another element of the system is the non-content criteria functionality element 162. Continuing with the example of a magazine, the user is able to customize her publication by adding and excluding other parameters. Some types of the non-content criteria items affect the look and feel of the magazine. Examples of such include the size of the print, the language in which the magazine is printed, and the percentage of pictures or illustrations that are printed in the magazine. In this regard, the particular language (e.g. English, French, etc.) could be specified for the magazine or on a by-article basis.

Alternatively, the magazine can be printed into two languages with the user's native language being printed on the right pages of the magazine, and the same articles being printed in a second language on the left pages of the magazine. As will be appreciated, this “two language” format would be beneficial as an educational tool to increase the subscriber's proficiency in a second language. This non-content criteria functionality 162 can be a separate function or be included as an integrated component.

Content from other magazines, publications, or other sources of information could be added to the magazine on a manual or automated basis through an external content inclusion element 168. For example, a subscriber to Time magazine could opt for an expanded sports section supplement from Sports Illustrated, Time's sister publication. Of course, adding external content could affect or modify the cost of the printed matter to the user. Preferably, any change in the subscription fee caused by the external content is displayed on the GUI 15 so that the user can immediately determine the effect of adding or deleting categories of advertising or content.

The output of the particular subscriber is transmitted preferably by an electronic connection to a print output device such as a digital printer, where the publication is printed. The information can be distributed to the end user via one or multiple devices. For example, a magazine can be distributed electronically to the user, who would then physically print the magazine on his printer at home, at his business, or at some third Party's printer. In such case, the output is transmitted electronically (such as by e-mail) to the user's device 10, or the information could be housed on a webpage so that the user could access the content via the webpage that was created with the personalized content created by the user. Alternatively, the printing can be electronic rather than physical, so that electronic devices such as an eBook, a PDA (Personal Digital Assistant), cell phone, web enabled TV, browser, web page, email, CDROM, Disc, and computer can make use of this methodology.

Additionally, centralized or remote digital printing equipment 34 can be used to produce a magazine whose content has been customized and personalized as previously described. One alternative that may efficiently combine the benefits of digital and traditional printing, comprises an individual's customized and personalized requests can be routed to a central data base. The data base then compares this request to all other received requests, or predicted requests, or historical requests, and then based upon other variables, forwards the job for printing to one of several distributed printing facilities. Among the variables that would be employed to help determine whether to send the publication to distributed printing facilities, and which of the distributed printing facilities to choose, are printing costs, transportation costs, postage costs, printing capacity, available digital printers and other equipment limitations or strengths, warehouse capacity, processing capacity, taxes, availability or cost of the materials necessary to produce the product.

The printing request may be routed to one of several distributed printing facilities via a program that has taken the aforementioned variables into account, and which has been further optimized to maximize the amount of similar printing output in each facility. In this particular solution, some of the efficiencies of traditional printing or efficiencies realized by longer digital printer runs could be realized. Consequently, a hybrid solution consisting of traditional printing devices (e.g., offset lithography) can be combined with digital printing devices to maximize efficiency or effectiveness.

The magazine (newspaper, or other physically or electronically printed matter), once printed, is then forwarded to an internal or third party mailing facility 36, from which the magazine is mailed to the user via the U.S. Postal Department or some private mail company such as FedEx® Digital printing equipment has the advantage of being able to efficiently print a customized and personalized copy of printed matter as a component of a print run without requiring the human printer to make any changes on the production line.

A wide variety of digital printing technologies exist currently. Among the numerous types of digital printing technology and processes known currently are direct image, digital photocopiers, printers that accommodate variable data, digital offset printers with Photo Imaging Plate (PIP) technology, direct to plate, Direct to Press (DTP), and so forth.

Of the various digital printing technolgies available, the present invention is preferably practiced with a masterless digital process. An advantage of a masterless digital process such as ink jet printing or electrophography, is that no cost is incurred in the creation of a physical master. This enables digital processes to be used for extremely short runs and for the printed images to be varied from impression to impression.

Numerous companies manufacture digital printing equipment, including but not limited to Indigo, America, of 400 Unicom Park Drive, Wobein Mass. (see www.indigonet.com); HEIDELBERGER DRUCK MASCHINEN, A. G., of Kurfursten-ANALAGE 52-60, 69115 Heidelberg, Germany; (see www.heidelberg.com) XEIKON NV, Vredebaan 72, 2640 Mortsel-Belgium (see www.XEIKON.COM); and the Xerox Corporation of 800 Long Ridge Road, Stamford, Conn. 06904 (see www.Xerox.com).

As one example, Indigo's Personalized, or variable data printing press—the Omnius WebStream press—offers high-quality personalized color printing for fully variable images and text, and whose content is driven by a data base. The Heidelberg Quickmaster DI press is fundamentally different from other digital devices, because it is a waterless offset lithographic press that employs digitally imaged printing plates made directly on the press. Among other benefits, the Quickmaster reduces the cost of makeready. Other exemplary digital presses include the XEIKON CSP 3200 color sheet feed press, and the XEROX DocuColor 130CSX digital color press, which employs a XEIKON print engine.

A digital press can change its entire image for every copy. This means that one can couple a database into the printer's workflow que and produce jobs where each copy is automatically created and tailored for a specific customer. The content can be personalized, or varied to meet the individual requirements of a specific customer. This can be accomplished by several methods. One method is to first create a standard design template, with the personalized and variable content being merged in to the template, usually from a data base source. Variable printing means that each printed piece can be different and that customized and personalized publication can be produced for a specific consumer, which has the potential to be significantly different from the publication printed for other customers.

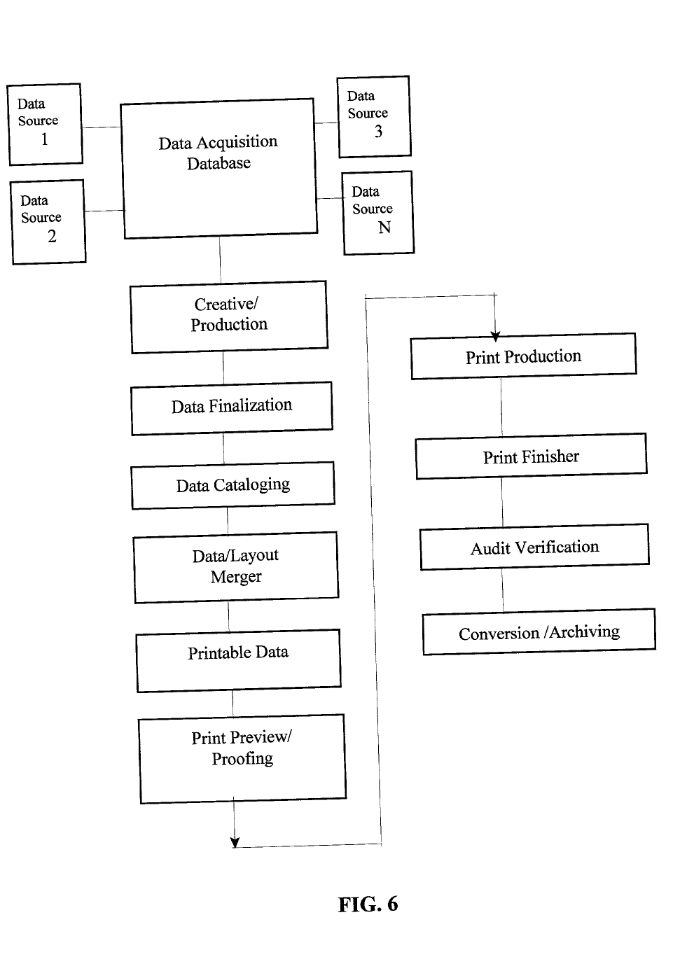

An alternative method for acquiring and producing the variable output print information will now be discussed in connection with FIG. 6.

The first step in the process is to provide a data acquisition database, into which data acquired from a variety of data sources, shown as data source 1(DS1), data source 2 (DS2), data source 3(DS3), . . . and data source N (DSN) can be melded and assembled together. The data sources DS1, DS2, DS3, DSN can be internal data sources, or as discussed above, can be external data sources, including such things as web-based, online data sources. The material in the databases, DS1-DSN, can include such things as data acquired from photos, CD Roms, and DVDs, digital photographs, material scanned into the data acquisition data base, text files and the like. The database software used for containing and searching the materials within the data acquisition database can be a commercially available database software program, such as for Microsoft Excel, File Maker, Fox Boro, Act, and Lotus.

The second step in the process is to transfer the desired material from the data acquisition database to a creative and production computer. Creative and production computer can be the same computer in which the data acquisition database is stored.

However, in a large organization, the data will be likely transferred from the data acquisition database to a computer or work station operated by a member of the publication's production department. The creative and production personnel take the raw data from the data acquisition database (such as a photograph), and design it and lay it out so it can be better included within the final publication.

This layout can include a variety of procedures practiced currently within the publishing industry, such as cropping pictures, editing text files, and configuring text files so that they are laid out appropriately to form an aesthetically pleasing, readable final page when published in the final publication. The lay out of the material can be accomplished through the use of several currently available software programs, including such programs as QUARK Express, Page Maker and Frame Maker. The choice of the particular program used depends largely upon the requirements of the material that needs to be laid out, the compatibility of the software with other components of the system, and the personal preferences of the user and/or company publishing the data.

The laid-out data undergoes a data finalization period. In the data finalization step, the laid-out materials are cleared up and organized for consistency and accuracy.

As will be discussed in detail below, the data that is assembled within the data acquisition database, laid-out, and finalized will likely comprise a plurality of discreet units of content materials. In producing the publication, it is likely that all of the screen units that are available for placement within the final publication will be acquired, produced and finalized. However, as the final content of the publication is variable, depending upon the particular desires of the subscriber, it is highly likely that not all of the various units will be incorporated into any particular user's publication. Rather, as discussed above, only those units of content that the subscriber desires, or which otherwise, are chosen based on the subscriber's profile, will be incorporated into a particular subscriber's final publication.

After the data is finalized, it is converted into a data stream where the data is cataloged according to certain meaningful criteria, such as subject matter, type (e.g. editorial content or advertising) and media type (e.g. graphic or text). The particular aggregate content is organized into identifiable units, to which standardized coding is attached. The standardized coding is utilized to help the publication assembly program match the relevant content and advertising, with a particular subscriber's predetermined desires and preferences.

The next step in the process is data construction and linking. In this step of the process, the particular data units of information that are relevant to the subscriber, based on the subscriber's preferences are chosen from the universe of data units obtained within the various data file database that contains all of the content units that potentially could be included. The data units that are most relevant to the subscriber are chosen, laid out according to criteria as set forth in the creative and production step, and are assembled to create an intermediate electronic version of the publication. This assembled and linked data is then converted into a data stream that contains all of the information necessary for a conversion from an electronic format into a printed format, for the subscriber's particular publication.

This data stream, that contains the specially chosen content units, information, ultimately becomes the subscriber's customized printed publication and comprises the printable data, that is then forwarded to the print preview/printing step of the process.

In the print preview/printing proofing step of the process, the data has the capability of being reviewed, either automatically through a computer, or by a human being, to determine what the final product that is being forwarded to the user will look like. Preferably, the creative and production step within the program will de designed to ensure that the electronic data, when it reaches the print preview/printing stage, will be correct and suitable for conversion into the printed media. However, in order to ensure that no glitches or other mistakes have occurred, it may be worthwhile to perform random “audits” on the printable data stream, to ensure that all of the electronic material will yield a correct and appropriate printed publication.

The next step in the process is the print production step. In this step, the electronic data that emerges from the print preview/printing stage (or from the printable data stream if no print preview or proofing occurs) is forwarded to a printer for printing upon a tangible media such as paper. Prior to printing however, the data stream is passed through a last or image process to facilitate its printing by a digital printer. As discussed above, several known digital printers can be used. However, for cost purposes, it is likely that a high speed, low cost printer, such as one capable of printing 100 pages per minute or greater, will likely be necessary in order to produce publications at the speed and of the cost that is acceptable to the publisher and to the subscriber.

After the printing sheets emerge from the printer, they are transferred to a post-print process, shown in FIG. 6 as a print finisher. In the print finisher process, the printed sheets are processed through a bindery and other appropriate finishing operations, so that the plurality of separable sheets that are printed by the printer are bound together into a collated, unitary publication. For a magazine, the post-print process will assemble the pages into a unitary unit having a look and feel of a traditional magazine. As with a traditional magazine, the size of the printed sheets, and the paper stock used to produce the final printed publication are variable, depending upon the preferences of the publisher.

The bound publications are then forwarded to an audit and verification step, where the output can be checked for correctness, in the publication process for mailing. Such processing may include wrapping or bundling the publication, affixing an address label and the like. However, the individualized nature of the printing of the publications of the present invention simplifies the audit and verification process, as the subscriber's name and address can be easily affixed to the publication during the printing process, along with appropriate postage payment information.

The final step in the process is that the electronic data that is forwarded to the printer is returned to the data acquisition database (or some other database) for archival purposes, and for future use. For record keeping purposes, it may not be necessary to return the data stream to the database. Rather, it may be necessary only to forward code units for archival purposes, if necessary, to enable the publisher to verify and determine which content units were included within the particular subscriber's publication.

Variable digital printing requires specialized equipment and software, which includes but is not limited to computer workstations (for scanning, page and image assembly, and output) and must be connected by a local area network. In some situations, a black-and-white or a digital color laser printer may be necessary for proofing, along with a high-speed data network, such as a 100Base-T Ethernet and a fast file server.

An archival system is often required, and can be a simple tape backup device like a DAT or DLT tape drive, or can be a robotic “jukebox” used to store optical discs. A fairly high-end scanner such as the Scitex EverSmart Pro, the Optronics Color Getter, or less expensive options can be used. A digital press and ancillary support equipment, depending upon the press requirement are required for the printing of the publication.

For post-press finishing, at a minimum, a guillotine cutter, a folder, and a mechanical binding system such as Wire-O can be used. Depending upon the application, collators, stichers, adhesive binding machines (e.g., OtaBind systems), trimmers, and other equipment will be necessary. Specific systems will require various types of software.

If required, a scanning station will utilize scanning software and possibly Photoshop and a page assembly station will require QuarkXPress and/or PageMaker (plus other applications necessary for support such as FrameMaker or Ventura). An ouput station will require imposition, perhaps trapping software, and software specific to the digital printing equipment. Press RIPs may require additional software, and typefaces may require purchasing the content, as some of the content may originate from third party sources that are not electrically linked to the data acquisition database. Removable media may be necessary so the digital printing press can accept various forms of media provided by these third party sources who provide some of the content material selected by the consumer. Examples of such removable media include Zip drives, Jaz drives, an optical drive (CD Rom and/or DVD drive) and others known now, and which may be invented in the future.

In summary, through the processes described above, a customized publication can be prepared to a subscriber which will have enhanced value to the subscriber, when compared with traditional publications and, has the potential for providing enhanced value and profitability to the publisher of the publication.

What is claimed:

1. A method of producing a mass distributed publication through the creation of a plurality of subscriber specific versions, comprising:
(1) obtaining subscriber profile information relating to the nature of the subscriber's content preferences,
(2) providing a content database containing a plurality of content items,
(3) using a computer to select content items from the content databases, based upon the subscriber's content preferences
(4) forwarding the selected item to a high speed digital printer capable of printing at least one hundred pages per minute; and
(5) assembling pages printed by the digital printer into a unitary publication.

2. The method of claim 1 wherein the mass distributed publication is reproduced in at least 1000 copies, and at least 50 subscriber specific versions are produced, and the printer comprises a color digital printer.

3. The method of claim 1 wherein the steps of obtaining subscriber specific information includes the steps of obtaining demographic and psychographic data about the subscriber.

4 The method of claim 1 wherein the step of obtaining subscriber specific information includes the steps of
(1) providing the subscriber with a plurality of subject matter content categories; and
(2) permitting the subscriber to choose subject matter categories from which the subscriber desires to have content included in the subscriber's subscriber specific version.

5 The method of claim 4 further comprising the steps of:
(1) providing at least one of the subject matter categories with at least wo subject matter sub-categories, and
(2) permitting the subscriber to choose those subject matter sub-categories which the subscriber desires to have included in the subscriber's subscriber-specific version.

6. The method of claim 5 further comprising the step of providing a scale selection for at least one of each of the subject matter categories and subject matter sub-categories for permitting the subscriber to attach a semi-quantitative interest value to the subject matter category and subject matter sub-category.

7. The method of claim 6 wherein the step of providing a scale selection includes the step of providing a pre-assigned default setting to the scale selection reflecting a publisher-determined semi-quantitative interest value.

8. The method of claim 4 further comprising the step of providing a scale selection for at least one of the subject matter categories for permitting the subscriber to attach a semi-quantitative interest value to the subject matter category.

9. The method of claim 8 wherein the step of providing a plurality of content units includes the step of providing a plurality of advertising content units, and the step of selecting certain of the content units includes the step of selecting certain of the advertising content units based upon the subject matter chosen and the scale selection chosen by the subscriber.

10. The method of claim 4 wherein the step of providing a scale selection includes the step of providing a pre-assigned default setting to the scale selection reflecting a publisher-determined semi-quantitative interest value.

11. The method of claim 10 wherein the publisher-determined semi-quantitative interest value is determined in response to scale selection made for other subject matter categories.

12. The method of claim 1 wherein the step of providing a plurality of content units includes the step of providing a plurality of advertising content units, and the step of selecting certain content units includes the step of the computer selecting certain of the advertising content units based upon the subject matter chosen by the subscriber.

13. The method of claim 12, further comprising the steps of
(1) establishing a relationship between the amount of advertising content units selected by the computer for inclusion in the publication and the price charged for the subscriber specific version and
(2) permitting the subscriber to vary the price paid for the publication by selecting the volume of advertising content units chosen for inclusion in the subscriber specific version.

14. The method of claim 1 wherein the step of providing a content database includes the step of providing content units from a plurality of content sources.

15. The method of claim 1, further comprising the steps of
(1) permitting the subscriber to make a selection to receive content from a plurality of content sources, and
(2) permitting the subscriber to influence the publication price paid by the subscriber through the subscriber's choices of content categories.

16. The method of claim 1 wherein the step of obtaining subscriber specific information includes the step of
(1) providing the subscriber with a plurality of subject matter content categories; and
(2) permitting the subscriber to choose those subject matter categories from which the subscriber desires to have content included in the subscriber's subscriber-specific version,
further comprising the steps of
(1) establishing a relationship between the subject matter content categories chosen by the subscriber and the price charged for the subscriber-specific version; and
(2) permitting the user to vary the price paid for the subscriber-specific version by selecting the subject matter content categories.

17. The method of claim 1 wherein:
(1) the step of obtaining subscriber profile information includes the step of obtaining demographic information about the subscriber;
(2) the step of providing a plurality of content items includes the steps of providing a plurality of advertising content units, and
(3) the step of selecting certain of the content units including the step of selecting certain of the advertising content units based upon the obtained demographic information about the subscriber.

18. The method of claim 1 further comprising the step of comparing the obtained subscriber profile information to the subscriber profile information of other subscribers to find other subscribers having similar profiles, wherein the step of using a computer to select content items include the step of selecting content items for the subscriber based upon the content preferences of the other subscribers having similar profiles.

19. The method of claim 18 wherein the step of comparing the obtained subscriber profile information to the subscriber profile information of other subscribers to find other subscribers having similar profiles comprises the step of finding other subscribers having similar demographic and psychographic profiles.

20. The method of claim 1 wherein the step of using a computer to select content items includes the step of providing an optimization program for
(1) selecting content items from the content database based upon the subscriber's content preferences and advertiser subscriber preferences, and
(2) assembling the selected content items into a publication data stream usable by the digital printer to print a completed subscriber specific version.

21. The method of claim 1 further comprising the steps of:
assembling an array of digital printers,
establishing a communication link between the computer and the array of digital printers, and
selecting one of the array of digital printers which to forward the selected content items based upon at least one of the criteria of: availability of the printer; capacity of the printer; and proximity of the printer to the subscriber.

22. The method of claim 21 wherein the array of digital printers including at least two digital printers, at least one of which is at a location geographically remote from the computer.

23. The method of claim 1 further comprising the step of
(1) comparing the subscriber-specific versions created, prior to printing, to uncover identically created subscriber-specific versions,
(2) determining whether the number of copies of any subscriber-specific versions created an excessive pre-determined threshold number of copies; and
(3) forwarding these identical subscriber-specific versions that exceed said threshold number to a non-digital printer.

24. The method of claim 1, further comprising the steps of:
(1) creating at least one non-specific content unit that will be included in at least a pre-determined number of subscriber-specific versions, and
(2) printing the non-specific unit on a non-digital printer, wherein the steps of assembling the pages printed by the digital printer into a unitary publication includes the step of joining the non-specific unit with the pages printed by the color digital printer.

25. The method of claim 1, further comprising the step of obtaining profile information from a plurality of subscribers and assembling the profile information obtained from the plurality of subscribers to provide a publisher-usable report containing the composite profile information from the plurality of subscribers.
